(19) United States
(12) Patent Application Publication
(10) Pub. No.: US 2008/0278289 A1
(43) Pub. Date: Nov. 13, 2008

(54) Method for the operation of an RFID tag with precise localization

(75) Inventor: Reinhold Gantner, Bludenz (AT)

Correspondence Address: BAKER & DANIELS LLP;111 E. WAYNE STREET, SUITE 800, FORT WAYNE, IN, 46802, US

(73) Assignee: IDENTEC SOLUTIONS AG, Lustenau (AT)

(21) Appl. No.: 12/112,064

(22) Filed: Apr. 30, 2008

(30) Foreign Application Priority Data
May 11, 2007 (DE) 10 2007 022 065.2

(51) Int. Cl. H04B 7/00

(52) U.S. Cl. 340/10.1

(57) ABSTRACT

The invention relates to a method for the operation of an RFID transponder (1, 2), wherein with the help of a marker (5-8) an inductive/magnetic near field (9-12) is generated whose field intensity is measured by the RFID transponder (1, 2) which transmits data to a reader, characterized in that at least two markers (5-8) are provided whose field intensities of the inductive/magnetic near fields (9-12) are measured by the RFID transponder (1, 2). As a result of this a good and precise localization of the transponder in the space in the case of the presence of different markers is achieved (FIG. 1).

The subject matter of the invention is a method for the operation of an RFID tag with precise localization according to the generic term of Patent claim 1.

The fact that one generates an inductive field with the help of a marker and triggers a transponder in this inductive field, which for its part transmits a specified data packet to a reader, belongs to the state of the art.

Up to now, however the arranging of a number of homogenous markers in a space whose near field may even overlap has not been known. Therefore it was not possible to allocate a transponder arranged in this space to a single marker.

Therefore it was not possible to carry out a precise localization of this transponder in the space.

The invention is therefore based on the object of developing a method for the operation of a transponder in such a way that a good and precise localization of the transponder in the space in the case of the presence of different markers is given.

For the achievement of the posed object the invention is characterized by the technical teaching of claim 1.

One significant feature of the invention is the fact that each marker generates an inductive near field and that the transponder is triggered by this near field.

A further significant feature of the invention is the fact that now the transponder carries out a field intensity measurement with the object of determining which inductive near field has the greatest field intensity at the specified area of the transponder.

Thus potentially the field intensity of all near fields received by the transponder is determined and the field intensities are compared to each other. The field intensity which is the greatest in its amplitude is a decision criterion in which proximity which inductive near field the transponder is located.

However, the invention is not restricted to this. The invention not only provides for the recording of the maximum of the field intensity of the closest near field, but rather it also considers the other field intensities of all other near fields acting on the transponder.

In the course of a mathematical trilateration the various fields are calculated with each other. After one is located (see later figure) in the near field, it is known that the near field decreases by an amount of 60 db/decade.

The position of the respective transponder can now be calculated.

With this a perfect localization of the transponder in the space in the case of the acting of several inductive near fields of markers on this transponder is possible.

Up to now this has not been known.

Thanks to the fact that the markers produce only inductive near fields and no far fields, it is very well possible on the basis of the distance-dependent attenuation (60 dB/decade) to enable a very precise localization of the transponder in the space.

This is a significant advantage compared to the far field comparison, in which case only a low attenuation takes place over the distance. In the case of the given change in distance of the transponder to the marker therefore the attenuation difference is very low, so that it can be evaluated only with great difficulty.

The invention therefore provides that the received field intensity of the transponder is recorded by markers transmitting in the near field.

In the case of very high frequencies, which for example lie in the UHF range, one has problems with field quenching (fading), which is prevented in the case of the present invention. Preferably a frequency range in the range of <20 MHz is selected for the inductive near fields of the individual markers.

The subject matter of the present invention arises not only from the subject matter of the individual patent claims, but rather also from the combination of the individual patent claims among themselves.

All information and features disclosed in the documents, including the abstract, in particular the spatial illustration represented in the drawings, are claimed as essential to the invention, provided they are new compared to the state of the art either individually or in combination.

In the following the invention will be explained in greater detail with the help of drawings representing only one embodiment. In this connection further features and advantages of the invention arise from the drawings and their description.

The figures show the following:

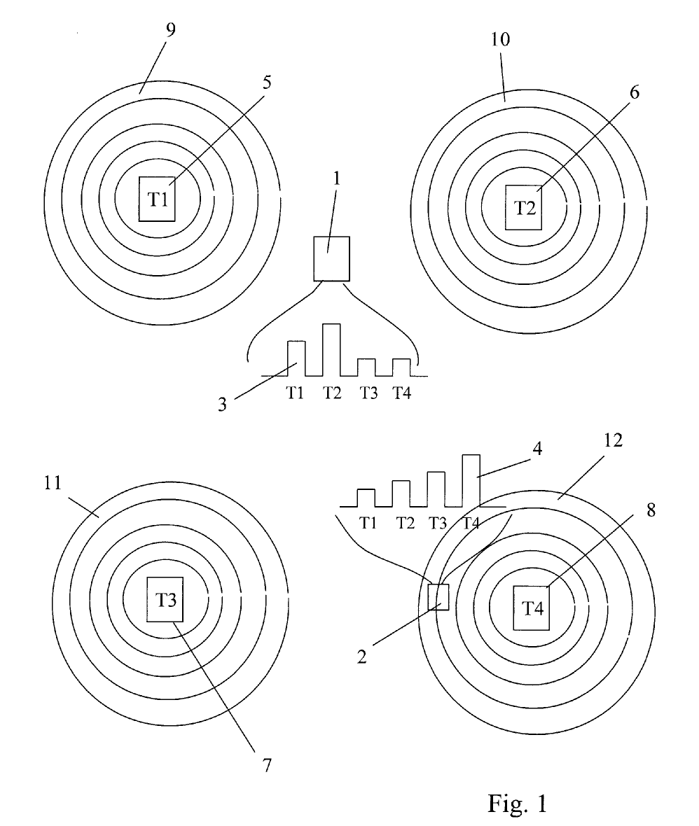

FIG. 1: schematized a top view of an arrangement of a transponder in two different local states in a near field, which is generated by four markers

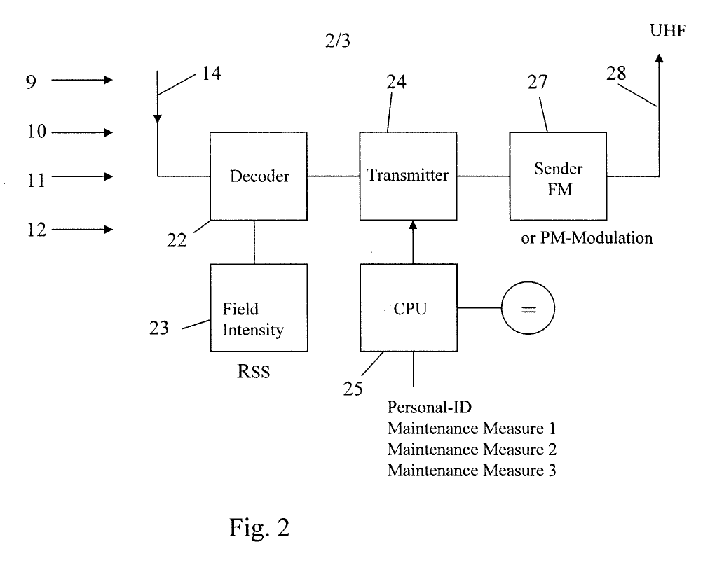

FIG. 2: the block diagram arrangement of a transponder with evaluation of the field intensity

In FIG. 1 in general a space is represented in which a total of four makers 5, 6, 7, 8 produce an inductive near field 9, 10, 11, 12.

In the case of the above named frequency range the near field—frequency-dependent—has a range of 10 cm to about 10 m.

A transponder 1 is arranged in this near field; said transponder receiving and evaluating the near fields 9-12 with its receiving antenna 14 (see FIG. 2).

With the field intensity evaluation 3 hence at a specified time the amplitudes of the near fields 9-12 are recorded and evaluated.

This then yields the field intensity evaluation 3 displayed there.

One recognizes that the transponder 1 is closer to the near field 10 than near field 9 comparatively and in other respects is further removed from near fields 11 and 12.

However if the transponder 1 is located in the place of a transponder 2 according to FIG. 1, then it can be recognized there that the transponder 2 is located directly in the near field 12 and the corresponding field intensity evaluation 4 shows that the near field 12 has the greatest field intensity.

Through a trilateration now the individual field intensity distributions in the field intensity evaluations 3, 4 are in communication with each other in such a way that one can now determine the precise location of the transponder 1 or 2 with relatively high resolution in the centimeter range in the space with reference to in reference to the near fields.

To this purpose in FIG. 2 it is represented in a diagram that at a specified time the near fields 9-12 act on the receiving antenna 14 of a decoder 22 of the transponder 1 or 2.

In the decoder the telegram from the marker of the near field 9-12 is decoded and the field intensity is determined in a field intensity module 23.

The decoded telegrams which are present in the decoder in the exit are used for the purpose of eliminating interferences. It can namely happen that magnetic noise fields act on the receiving antenna 14 and through the coding of the near fields 9 with corresponding data telegrams in the decoder 22 decide whether it is a matter of a recordable near field 9-12 or a magnetic noise field which is to be faded out.

Therefore through the corresponding data telegram, which is allocated to each individual near field 9-12, it can also be decided which near field of which marker 5-8 it is a matter of. With this a unique allocation of the near field to the respective marker is given.

At the exit thus an evaluation 24 of the corresponding data diagram takes place in the evaluation circuit, and with the help of a CPU 25 the decision making is carried out, which near field is allocated to which marker.

The result of the near field consideration is given to a transmitter 27, which for example gives as a frequency modulated or phase modulated signal or an amplitude modulated signal in a specified transmitting range to a transmitting antenna 28, which in communication with a reader not shown in greater detail.

In the reader now the local information is finally received, at which place in the space the transponder 1 is precisely located in reference to the generated near fields 9-12.

In the represented embodiment the implementation was described in which case the transponder itself carries out its near field consideration and makes available the location information through the built-in CPU and the evaluation circuit and transmits to a remote reader.

However the invention is not restricted to this.

In another embodiment of the invention provision can be made that a corresponding evaluation in the transponder is omitted and only for example a field intensity consideration takes place in the transponder and that in a higher-level arithmetic-logic unit, which for example is arranged in the reader, the local field (localization)-determination is taking place.

Accordingly in the case of this second embodiment only the field intensity values are to be transmitted together with the evaluation of the data diagrams and then the local information is to be calculated in the higher-level arithmetic-logic unit (for example a reader).

In a preferred embodiment the calculation of the local information takes place by means of the known trilateration method.

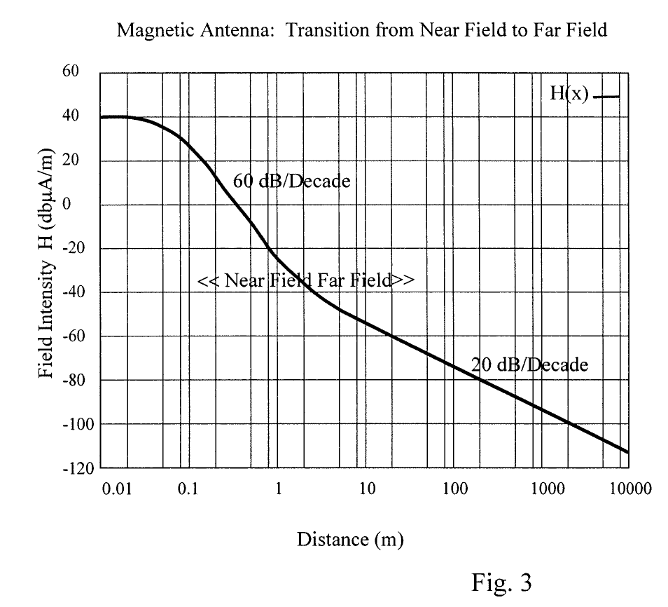

In FIG. 3 of the present invention the definition of the near field is specified, from which it can be detected how the near field is defined.

The primary magnetic field generated by a conductor loop begins directly at the antenna. In the case of the propagation of the magnetic field through induction also an electric field develops increasingly. The originally pure magnetic field thus transitions continuously to an electromagnetic field. At the distance λ/2π in addition the electromagnetic field begins to detach from the antenna and to wander as an electromagnetic wave in the space. The region from the antenna up to the development of the electromagnetic field is termed as the near field of the antenna. The region beginning at which the electromagnetic field is completely developed and has detached from the antenna is termed as the far field.

A detached electromagnetic field can no longer react through inductive or capacitive coupling to the antenna from which it was generated. For inductive coupled RFID systems this means that with the beginning of the far field a transformational (inductive) coupling is no longer possible. The beginning of the far field (with the radius r_{F}=λ/2π as a rough reference value) around the antenna thus represents an uncrossable range threshold for inductive coupled systems.

The field intensity course of a magnetic antenna along the coil axis x follows in the proximity zone of the relationship 1/d³, as already shown above. This corresponds to an attenuation of 60 dB per decade (of the distance). In the transition to the far field on the other hand a smoothing of the attenuation course occurs, since after detachment of the field from the antenna for the field intensity course exclusively the free-space attenuation of electromagnetic waves is of importance. The field intensity then diminished with increasing distance only in the ratio of 1/d. This corresponds to an attenuation of only 20 dB per decade (of the distance).

The purpose of the present application is a precise place localization of transponders in space, this can e.g. happen when in a larger storage room a multitude of boxes crates equipped with transponders are present and it cannot be precisely determined precisely where the box is in the room. Here markers can be arranged stationary in the room and generate correspondingly defined near fields and with the given invention it can now be precisely determined at which place in the room the box being searched for is located.

Another embodiment of the present invention consists in the fact that above a running production line, e.g. in the motor vehicle industry in the case of the production of a motor vehicle a number of markers are fastened stationary, said markers generating a very short inductive near field. This near field operates in the direction of a passing carriage which is in the production process, wherein each carriage is provided with a transponder.

Likewise a worker who performs specified activities on the carriage carries a transponder with him. Stated more precisely, this transponder is arranged on the worker's tool.

Through the specified localization in accordance with the present invention it is possible without further ado to produce a perfect allocation of the tool of the user to the vehicle which is currently being worked on by the user. In this way a perfect documentation can be prepared of which tool at which time at which place of the production line has acted on a vehicle and performed the corresponding production operations there.

### DRAWING LEGEND

1 Transponder

2 Transponder

3 Field intensity evaluation

4 Field intensity evaluation

5 Marker (inductive beacon transmitter)

6 Marker (inductive beacon transmitter)

7 Marker (inductive beacon transmitter)

8 Marker (inductive beacon transmitter)

9 Near field

10 Near field

11 Near field

12 Near field

13

14 Receiving antenna

15

16

17

18

19

20

21

22 Decoder

23 Field intensity module

24 Evaluation

25 CPU

26

27 Transmitter

28 Transmitting antenna

1. A method for the operation of an RFID transponder wherein with the help of a marker an inductive/magnetic near field is generated whose field intensity is measured by the RFID transponder which transmits data to a reader, characterized in that at least two markers are provided whose field intensities of the inductive/magnetic near fields are measured by the RFID transponder.

2. The method according to claim 1, characterized in that the inductive near fields possess an attenuation of circa 60 dB/decade of the distance.

3. The method according to claim 1, characterized in that the near fields of at least two markers are measured by the RFID transponder.

4. The method according to claim 1, characterized in that the near fields of at least two markers overlap.

5. The method according to claim 1, characterized in that in the course of a mathematical trilation the different field intensities of the inductive near fields are calculated with each other and the distance of the marker from the RFID transporter is calculated.

6. The method according to claim 1, characterized in that a frequency range for the inductive near fields of the individual markers is selected in the range of less than 20 MHz.

7. The method according to claim 1, characterized in that at a certain time the near fields act on receiving antenna of a decoder of the transponder and in the decoder a telegram from the marker of the near field is decoded and the field intensity of the near fields is determined in a field intensity module.

8. The method according to claim 7, characterized in that at the exit of the decoder (22) an evaluation of the corresponding data diagram takes place in an evaluation circuit (24) and with the help of a CPU (25) the decision making is carried out which near field (9-12) is allocated to which marker (5-8) and that the result of the near field consideration is given to a transmitter (27) which for example gives as a frequency modulated or phase modulated signal or an amplitude modulated signal in a specified transmitting range to a transmitting antenna (28), which is in communication with the reader in the reader now the local information is finally received, at which place in the space the transponder 1 is precisely located in reference to the generated near fields 9-12 at which place in the space the transponder (1, 2) is precisely located in reference to the generated near fields (9-12).

9. The method according to claim 7, characterized in that the local field (localization)-determination is taking place in a higher-level arithmetic-logic unit, which for example is arranged in the reader.

10. The method according to claim 2, characterized in that the near fields of at least two markers are measured by the RFID transponder.

11. The method according to claim 2, characterized in that the near fields of at least two markers overlap.

12. The method according to claim 3, characterized in that the near fields of at least two markers overlap.

13. The method according to claim 2, characterized in that in the course of a mathematical trilation the different field intensities of the inductive near fields are calculated with each other and the distance of the marker from the RFID transporter is calculated.

14. The method according to claim 3, characterized in that in the course of a mathematical trilation the different field intensities of the inductive near fields are calculated with each other and the distance of the marker from the RFID transporter is calculated.

15. The method according to claim 4, characterized in that in the course of a mathematical trilation the different field intensities of the inductive near fields are calculated with each other and the distance of the marker from the RFID transporter is calculated.

16. The method according to claim 2, characterized in that a frequency range for the inductive near fields of the individual markers is selected in the range of less than 20 MHz.

17. The method according to claim 3, characterized in that a frequency range for the inductive near fields of the individual markers is selected in the range of less than 20 MHz.

18. The method according to claim 4, characterized in that a frequency range for the inductive near fields of the individual markers is selected in the range of less than 20 MHz.

19. The method according to claim 5, characterized in that a frequency range for the inductive near fields of the individual markers is selected in the range of less than 20 MHz.

20. The method according to claim 2, characterized in that at a certain time the near fields act on receiving antenna of a decoder of the transponder and in the decoder a telegram from the marker of the near field is decoded and the field intensity of the near fields is determined in a field intensity module.
